(19) United States
(12) Patent Application Publication
(10) Pub. No.: US 2005/0180827 A1
(43) Pub. Date: Aug. 18, 2005

(54) Machine tool with a headstock

(76) Inventor: Heinrich Lutz, Dirlewang (DE)

Correspondence Address: JACOBSON, PRICE, HOLMAN & STERN;PROFESSIONAL LIMITED LIABILITY COMPANY, 400 Seventh Street, N.W., Washington, DC, 20004, US

(21) Appl. No.: 11/052,757

(22) Filed: Feb. 9, 2005

(30) Foreign Application Priority Data
Feb. 13, 2004 (DE) 10 2004 007 472.0

(51) Int. Cl. B23C 1/00

(52) U.S. Cl. 409/134; 409/235

(57) ABSTRACT

The invention refers to a machine tool with at least one headstock for one or more tool spindle(s) with a spindle head, where the headstock can be shifted in the direction of the spindle axis, the machining room of the machine tool is limited by a wall, the headstock projects through an opening into the machining room, and the tool spindle carries on its front end a tool projecting into the machining room. The invention is characterised by the fact that at least one guide block for the headstock is provided which can move on a guide rail, and the headstock carries the guide block.

The invention refers to a machine tool with at least one headstock for one or more tool spindle(s) with a spindle head, where the headstock can be shifted in the direction of the spindle axis, and the machining room of the machine tool is limited by a wall, the headstock projects through an opening into the machining room, and the tool spindle carries a tool on its front end projecting into the machining room.

### BACKGROUND OF THE INVENTION

Machine tools of this type are known. It is usually here to design one or more tool spindles in headstocks, respectively in so-called spindle sleeves, in such a way that they can be shifted in the direction of the spindle axis.

In the prior art, for example, a machine tool and a method for adjusting a spindle position of this machine tool is known. In this suggestion of a solution a machine tool is proposed which has at least one spindle which may be positioned in the space. The spindles are here supported over rods on shiftable slides. The shifting of the slides causes a positioning of the spindle in the space. That means, the spindle itself is not guided on rails or supported in such a way that it is introduced on a fixed position in the machining room. In the cited solution rather a machine tool with rod kinematics is described. Machine tools of this kind are meant for special machining purposes, and not for machinings which can be realised with a machine tool with a headstock of the kind discussed.

For that purpose it is, for example, provided that on a spindle sleeve body a guide rail is arranged which extends over the complete length of the spindle sleeve. The arrangement here is formed in such a way that a vertical steel cover is provided through which the spindle sleeve projects into the machining room. In the state of the art for that it is also known that the spindle sleeve carries the guide rail as by means of that a constant contour may be realised, which is an advantage in particular for sealing the working room at the opening in the machining room. The front part of the guide rail here projects into the machining room, that is when the headstock, respectively the spindle sleeve has been shifted to the front in the direction of the spindle. If there are slides provided for the spindle sleeve, they are behind the cover, that means not in the machining room.

If now the headstock has to carry out a large lifting movement in the direction of the spindle axis the problem occurs that a comparatively long region of the headstock is designed in a freely protruding way. The reason for that is that the first guide block on the guide rail has to be set back accordingly so far that a large lifting movement in the direction of the spindle axis is possible at all. This freely protruding design, however, leads to the problem that the spindle region is prone to vibrations. It has to be taken into consideration here that the machining spindle rotates with a considerable speed, and this freely protruding spindle region has an inherent frequency which leads, in the case of resonance, to a building up of the inclination of vibrations.

As a result a so-called rattling of the tool could be observed on the work piece which is in no case desired, because by means of that the tool as well as the wok piece can be damaged.

### BRIEF SUMMARY OF THE INVENTION

Therefore it is an object of the invention to provide a machine tool with a machining spindle which is preferably arranged in a headstock, which is able to carry out, on the one hand, a large lifting movement in the direction of the longitudinal axis of the spindle, and, on the other hand, is sufficiently stable to avoid undesired vibrating.

In order to solve this problem the invention comes from the state of the art described above, and proposes to provide a machine tool with at least one headstock for one or several tool spindles with a spindle head, where the headstock can be shifted in the direction of the spindle axis, and where the machining room of the machine tool is limited by a wall, the headstock projects through an opening into the machining room, and the tool spindle has, on its front end, a tool projecting into the machining room, which is characterised in that at least one guide block for the headstock is provided which can move on a guide rail, and the headstock carries the guide block. By means of this embodiment of the machine tool according to the invention it is now possible to carry out a large lifting movement in the direction of the longitudinal axis of the spindle, the spindle being sufficiently stable. An undesired vibrating is avoided now as the guide block carries the headstock and stabilises it sufficiently. By means of that in particular the undesired, so-called rattling or an undesired balance error by building-up of vibrations of the tool because of the building-up movement of the spindle is avoided. The spindle itself is no more designed freely protruding to such an extent, as it was necessary according to the state of the art with the same lifting length. In this respect the problems of the state of the art, as described above, are solved in a very elegant way, namely by the fact that the slide is carried by the headstock or even by a spindle sleeve with a tool, and thus gets sufficient stability. In the same way the guide rails can be stabilised by other technical means, as it will be described sufficiently in the following.

From the solution of a machine tool with rod kinematics known from the state of the art the solution now proposed by the invention differs by the fact that the headstock is supported on a guide rail. By means of that it cannot be positioned freely in the space, but only be positioned guided. In contrast to the machine tool with headstock, however, the solution proposed now has the advantage that, within the machining room, the headstock can be run out essentially more. This may be carried out in particular without the negative vibrations otherwise known from the state of the art, respectively without the building-up process which has a negative effect. In machine tools with a rod kinematics the spindle, respectively the headstock, is additionally supported at, respectively on, a mechanism plate. This is then connected via rods with the frame, respectively on slides guided there for the rods. The positioning is carried out by shifting the slides so that the rods can act on the mechanism plate, respectively on the spindle or the headstock. This is a completely other machine conception which, as already mentioned, allows free positioning in the machining room, at least at different levels. In contrast to that the solution suggested now is constructed simpler, and allows the spindle to run deeper into the machining room without loosing its stability. Even the sealing of the machining room in the solution suggested now can be realised considerably more easily than it is the case with solutions according to the state of the art, and even with solutions of machine tools with rod kinematics. In machine tools with rod kinematics it is, for example, necessary that the cover the machining room be designed telescope-like in order to allow the different positioning at different height level at all, without the driving regions, respectively the spindle support, being soiled.

According to the invention it is provided according to a development of the machine tool that the guide rail, respectively the guide rails, project(s) into the machining room of the machine tool. By means of that it is achieved that the spindle can move far enough into the machining room, if this is necessary. The guide rails themselves do not impede the machining process as they project only so far into the machining room as it is necessary, on the one hand, and, on the other hand, does not restrict the freedom of movement of the work piece which has to be machined. By the way, the work piece which has to be machined can also be positioned above the level where the guide rails are arranged in order to prevent a collision. This is possible technically in the usual way.

In a preferred modification of the invention it is provided that at least one guide block runs through the opening of the wall. The embodiment according to the invention makes it possible that now the guide blocks run into the machining room, and thus make it possible that the tool spindle exercises, in the direction of the spindle axis (Z-direction), a considerable long lifting movement. In the known arrangements the guide block always remained behind the wall as this was arranged stationary and the spindle sleeve carried the guide rail. The result from that, however, is another contribution for reducing an inclination for vibrating as the freely protruding length of the headstock is reduced clearly, and at the same time the lifting movement in Z-direction of the spindle is very large.

A development of the invention is characterised by the fact that on the wall a balcony, which carries the guide rail, is provided which projects into the machining room. This measurement as well contributes to a stabilisation altogether. It supports in particular the guide rails which are mostly designed slenderly. The inclination of vibrating is further reduced by this measurement. The opportunity arises here that, with very long lifting movements, the guide rails are supported reliably and stable. Preferably, because of the requirements of stability it has been tried to design the guide rails in one piece.

Alternatively to the solution mentioned before in another modification of the invention a carriage or a support which carries the guide rail is provided on which a balcony projecting into the machining room is provided. The arrangement of the spindle, for example, is designed stationary on a support and allows the tool to move only in the direction of the spindle axis, that is in the Z-direction. In such a case the spindle is arranged on a support. In another modification the guide rail is located on a carriage which is known, for example, also as transverse carriage. By means of the arrangement of the balcony either on the support or, in particular, on the carriage the balcony executes exactly the same movement as the rest of the guide rail.

In this connection it is an advantage if the wall is held, for example, by the carriage or the support. The wall is here, for example, designed like a telescope, in particular if, for supporting the spindle, a carriage is provided.

The modifications of the invention described above are thought for embodiments with one (if necessary wide and stable) guide rail as well as with several guide rails. A development of the invention therefore provides that two or more guide rails are provided on the machine tool fixedly and with a distance to one another, in particular below the headstock. By means of this measurement a further stabilising of the complete headstock, respectively the rotating spindle is achieved. By means of the support on two guide rails a better support is guaranteed than it is given, for example, with an embodiment with only one guide rail. Also the complete construction of the headstock for such a two-sided guide can be designed more convenient altogether.

According to the invention it is provided that, together with headstock, not only one spindle is moved but rather several spindles can be supported, respectively positioned, in one headstock according to the invention.

The invention is also characterised by the fact that the headstock has several guide blocks, and the guide block closest to the tool is set back versus the tool. By this measurement it is achieved that the headstock can move very far into the machining room without loosing the necessary stability, and, nevertheless, can do without freely protruding wide which would be necessary otherwise.

It is also an advantage if the balcony has the width of the headstock. This also leads, as all measurements described before, to a further stabilising of the complete translator construction. The vibrations are reduced further and a building-up process is prevented. By means of the design of the machine tool with a balcony of this type it is, besides a possible longer lifting movement, also achieved that, if necessary, the freely protruding length of the headstock is not enlarged, but rather can be reduced. The length of the balcony is here dimensioned in such a way that it corresponds roughly with the length of the spindle head which projects into the working room anyway, including the tool, and thus does not impede, for example, maintenance or tool changes.

Another aspect of the machine tool according to the invention is given by the fact that at least one protection device running together with the headstock is provided. It is, for example, designed and arranged in such a way that a soiling of the guide rail protruding into the machining room is avoided. It is in particular important here that during the forward movement of the guide block the guide rails are clean. In this respect it is convenient if, besides the dirt of the guide rails, simultaneously measurements are taken to clean the guide rail, respectively rails, during the forward movement into the machining room. Either possibility is provided by the invention.

For that purpose according to an advantageous development of the machine tool of the invention it is, for example, suggested that the protection device is designed as cover, for example as sheet metal which is U-shaped, embraces the headstock, is open at the bottom and attached to the headstock. Already by this measurement it is achieved that chips coming loose by the machining, and possibly even coolant, respectively flushing liquid, cannot reach the guide rail and the headstock.

A design of the development described above is characterised by the fact that on the cover or the wall of the machining room a wiping lip which follows at least partly the contour of the opening is provided. The combination of a cover sheet with a wiping lip is very convenient as, by means of that, without great machine and technical effort in a simple manner the protection as well as the cleaning of the moving machine parts is guaranteed. Thus, for example, during drawing the backward movement of the headstock out of the machining room possibly adhering coolant, respectively rinsing agent, and chips are just wiped off. Thus the cover and the wiping lip act together and provide a permanently clean surface of the headstock and the guide rails, which, of course, does not prevent the mobility of the guide block, either.

A development of the invention provides in reverse of the principle described before that on the wall, respectively in the opening for the passing of the headstock in the machining room a tunnel is provided as protection device, and the wiping lip is attached to the headstock and moves together with it. By means of this it is also achieved that the headstock remains clean all the time. It has only to be secured that the wiping lip is arranged on the front end, that means on the end facing the machining room, in order to prevent chips, respectively coolant and flushing liquid, from reaching in the back part of the headstock.

A development of the machine tool according to the invention provides as protection device an even casing of the headstock which is formed by a sheet metal drawn down laterally on the headstock which also covers the guide rail. This is a very elegant solution for the protection of both machine parts. The invention is also characterised by the fact that a wiping rail running together with the headstock is provided which corresponds with the contour of the guide rail, respectively the opening for the headstock, in the wall of the machining room.

It is an advantage here, if the wiping rail consists of several pieces. This can technically be solved simply and guarantees a complete protection of headstock and guide rails.

As an alternative it is provided that the wiping rail is formed by a special profile sheet metal with wiper. The wiping rail is designed here as one piece, the profile sheet metal being adapted to the desired contour in the region of the guide rail and/or below the headstock, and this profile sheet metal being connected at its end faces with a suitable sealing lip, for example made of rubber, to form thus the wiper. The invention comprises a one-piece as well as a several-pieces design of this wiping rail.

Of course, the wiping rail may also have lips. It is also an advantage if, as provided according to a development of the invention, the other part of the wiping rail is arranged below the headstock. This is also an effective constructive measurement which makes the adjustment of the wiping rail in the bottom part of the headstock easier, as regularly in this part the contours become slightly more complicated than in the top part where there are even contours.

It has also been found to be an advantage if in the end of the headstock facing in the direction of the machining room brushes are arranged as protection against dirt. These brushes protect in particular the region where the guide rails interact with the guide block. At the same time the brushes are also provided for cleaning the guide rails during moving back and forth.

In order to increase the possible axes of movement which have to be carried out by the tool spindle it is provided, according to the invention, that a carriage carries the guide rails for the guide block of the headstock, and can be shifted at least transverse to the longitudinal axis of the spindle. By this measurement a further shifting possibility of the spindle, for example additionally to the Z-direction in the X- and Y-direction of a machine tool, can be reached.

The invention also presents a headstock for a machine tool which is characterised by the fact that it carries a guide block which can move on guide rails in the machining room of a machine tool, in particular a machine tool as described before. This headstock is provided for retrofitting certain machine tools which are not yet fitted with a headstock of this type. In this respect all advantages as described before for the machine tool, go in the same way for the headstock when it has been built into a machine tool.

It is, in particular an advantage if the headstock according to the invention is designed in such a way that the headstock has several guide blocks, and the guide block closest to the tool is set back versus the tool. By means of that a certain protruding length is achieved. Here the headstock can be shifted on the guide rail in such a way that the guide block can run through the wall which limits the machining room.

The invention also presents a method for cleaning the guide rails, in particular the guide rails of a headstock in a machine tool as described above. The method according to the invention is characterised by the sequence of the following process steps:
The headstock is run into the machining room of a machine tool,
A wiping rail arranged on the headstock runs up to the end of the guide rail projecting into the machining room, and, simultaneously, wipes off the deposited dirt and
After that the spindle is moved back.

The method as described before guarantees in the usual machining process with normal spindle movements the cleaning of the guide rails. However, in the same way it is possible to carry out a cleaning separately, that means in particular for cleaning purposes, where the process steps cited above are carried out one after the other.

A development of the method described before is characterised by the fact that brushes arranged on the headstock protect, respectively brush, the guide rails at least during moving back of the headstock.

### BRIEF DESCRIPTION OF THE DIFFERENT VIEWS OF THE DRAWINGS

In the following the invention is described further by means of examples.

In the drawings:

FIG. 1: a view of a part of the machine tool seen from the machining room,

FIG. 2: a side view of the spindle head,

FIG. 3: another side view of the spindle head in another machining position.

### DETAILED DESCRIPTION OF THE PREFERRED EMBODIMENTS

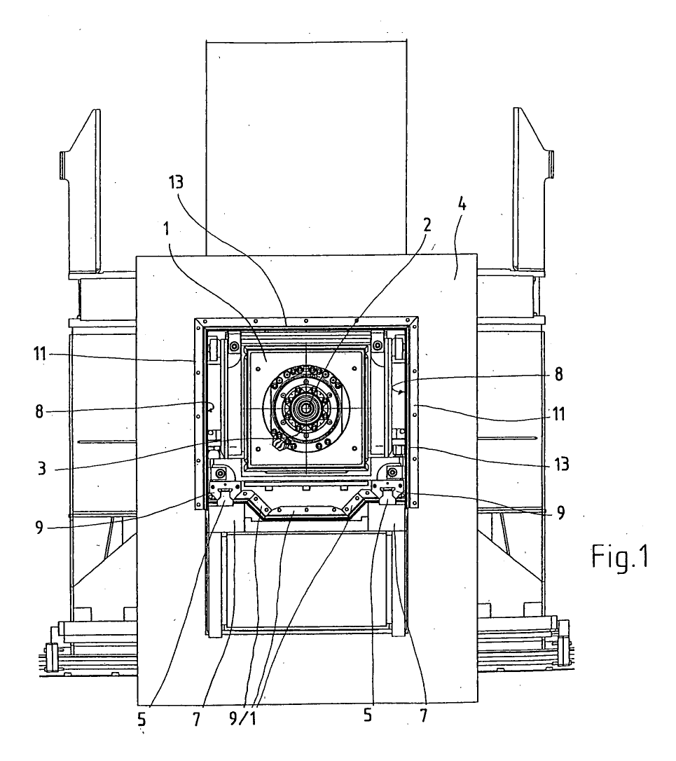

FIG. 1 shows a part of a machine tool seen from the machining room I. Reference number 1 here indicates the headstock. The tool spindle itself has reference number 2. The spindle head 3 is the one to project deepest into the machining room I, and carries the machining tool. The machining room I is limited by a wall 4 which has an opening 11 through which the headstock 1 can move back and forth.

According to the invention the headstock 1 can execute a large lifting movement in Z-direction, that is in the longitudinal direction of the spindle. In order to protect the guide rail 5 as good as possible from loose chips a protection device is provided.

It consists, for example, of a cover 8 which runs together with the headstock and is therefore attached to the headstock.

The cover 8, for example, is made from a U-angled sheet metal, this U-sheet being pushed on the headstock 1 from above in such a way that the U is open on the bottom. The sides of the cover 8 are drawn down so far here that they project downward over the guide rails 5.

Besides a separate U-shaped sheet metal which is put on the headstock 1 as cover 8, it is, of course, also possible to design the casing of the headstock 1 accordingly.

The protection device, respectively the cover 8, here interacts with a wiping lip 13 which is attached to a L-shaped sheet metal on the wall 4, and follows the contour of the opening 11. The wiping lip 13 here covers a possible gap between the cover 8 and the wall 4. At the same time the dirt on the cover 8, is wiped off by the movement back and froth of the headstock 1.

Below the headstock 1 a wiping rail 9 is provided. It is, for example, built of one or more parts 9/1. This wiping rail has itself suitable means for sealing a possible gap. The wiping rail 9 runs together with the headstock 1. The wiping rail 9 here embraces the contour of the guide rail 5 as well as the other bottom region below the headstock 1, respectively the region left open by the cover 8.

Reference number 7 is the balcony on which the guide rails 5 are supported.

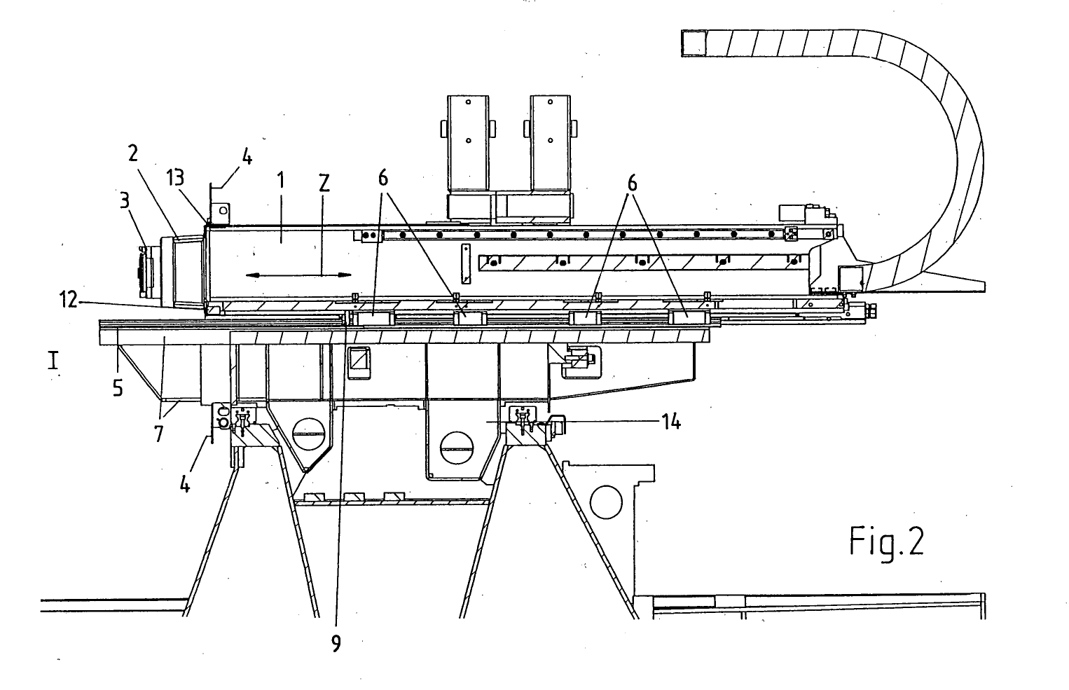

FIG. 2 shows a side view of a part of the machine tool according to the invention. This concerns in particular the headstock 1, which carries, according to the invention, the guide blocks 6. The guide blocks 6 move on guide rails 5. The guide rails 5 themselves are supported by a balcony 7. This balcony 7 projects, in particular, into the machining room I of the machine tool so that the headstock 1 can be run essentially more to the front into the machining room I, without the risk of the negative consequences of protruding too large, namely vibration attitude and, connected with it, a built-up process. The headstock 1 can shift along the direction of the longitudinal axis Z indicated by the double arrow. The balcony 7, respectively the guide rail 5, are arranged in the shown embodiments on a carriage 14 which can shift transverse to the Z-direction.

Reference number 12 indicates brushes arranged on the front end of the headstock 1, and, in particular, protecting the guide rails 5, and simultaneously cleaning them. Reference number 9 indicates a wiping rail which runs together with it, and which is also arranged for the protection of the guide rails 5. Reference number 4 indicates schematically the wall of the machining room I. By means off a wiping lip 13 the wall 4 is sealed, for example on the top edge of the headstock toward the machining room I.

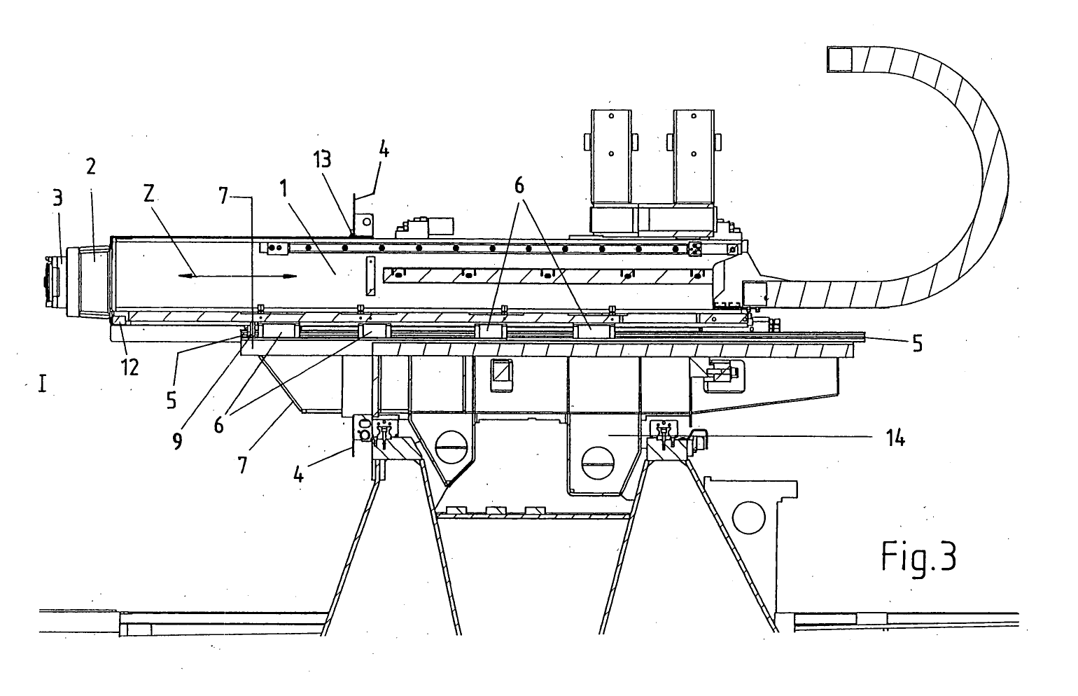

FIG. 3 shows a side view of FIG. 2, however, in a position of the spindle of the headstock which is more drawn forward. It can be seen clearly that the headstock 1 projects essentially more into the machining room I than, for example, in the drawing of FIG. 2. By means of the drawing of FIG. 3, however, the advantages according to the invention become particularly clear, because it is obvious how much the spindle, respectively the headstock 1, can be moved into the machining room I without the risk of a building-up process. This is also achieved according to the presented embodiment of the invention, by the balcony 7 which carries the guide rails 5 which project roughly so far into the machining room I as the spindle head 3 inclusively the tool in the machining room in the position drawn back farthest. Therefore the object of the invention, namely to reach a higher stability of the spindle and to avoid a building-up and rattling of the tool on the work piece, is achieved in a very impressing and convenient way. All other reference numbers and characteristics have already been described in the previous figures so that another presentation is not necessary.

Although the invention has been described by exact examples which are illustrated in the most extensive detail, it is pointed out that this serves only for illustration, and that the invention is not necessarily limited to it because alternative embodiments and methods become clear for experts in view of the disclosure. Accordingly changes can be considered which can be made without departing from the contents of the described invention.

1. Machine tool with at least one headstock for one or more tool spindles with a spindle head, where the headstock can be shifted in the direction (Z) of the spindle axis, the machining room of the machine tool is limited by a wall, the headstock projects through an opening into the machining room, and the tool spindle has on its front end a tool projecting into the machining room, characterised in that at least one guide block for the headstock is provided which can move on a guide rail, and the headstock carries the guide block.

2. The Machine tool according to claim 1, characterised in that the guide rail projects into the machining room.

3. The Machine tool according to claim 1, characterised in that at least one guide block runs through the opening of the wall.

4. The Machine tool according to claim 1, characterised in that on the wall a balcony projecting into the machining room is provided which carries the guide rail.

5. The Machine tool according to claim 1, characterised in that at least two guide rails are provided on the machine tool, fixedly and at a distance from one another, in particular below the headstock.

6. The Machine tool according to claim 1, characterised in that a carriage or support is provided which carries the guide rail and on which a balcony is provided projecting into the machining room.

7. The Machine tool according to claim 1, characterised in that that a carriage or a support is provided which carries the guide rail, and on which a balcony projecting into the machining room is provided, and the wall is held by the carriage or the support.

8. The Machine tool according to claim 1, characterised in that the headstock has several guide blocks, and the guide block which is closest to the tool is set back versus the tool.

9. The Machine tool according claim 1, characterised in that on the wall a balcony projecting into the machining room is provided, which carries the guide rail, and the balcony has the width of the headstock.

10. The Machine tool according to claim 1, characterised in that on the wall a balcony projecting into the machining room is provided which carries the guide rail, and the length of the balcony is dimensioned in such a way that it corresponds roughly to the length of the spindle head projecting into the machining room, including the tool.

11. The Machine tool according to claim 1, characterised in that at least one protection device is provided running together with the headstock.

12. The Machine tool according to claim 1, characterised in that at least one protection device is provided running together with the headstock, and the protection device is designed as cover, for example, as sheet metal which is U-shaped, embraces the headstock and is open on the bottom and is attached to the headstock.

13. The Machine tool according to claim 1, characterised in that at least one protection device is provided running together with the headstock, and the protection device is designed as cover, for example, as sheet metal which is U-shaped, embraces the headstock, is open on the bottom and is attached to the headstock, and that on the cover or the wall of the machining room a wiping lip is provided following at least partly the contour of the opening.

14. The Machine tool according to claim 1, characterised in that on the wall, respectively in the opening, a tunnel is provided as protection device, and a wiping lip following at least partly the contour of the opening is attached to the headstock and runs together with it.

15. The Machine tool according to claim 1, characterised in that at least one protection device is provided running together with the headstock, and as protection device an even casing of the headstock is provided, formed by a sheet metal drawn down laterally on the headstock which also covers the guide rail.

16. The Machine tool according to claim 1, characterised in that a wiping rail is provided running together with the headstock which corresponds to the contour of the guide rail, respectively the opening for the headstock in the wall of the machining room.

17. The Machine tool according to claim 1, characterised in that a wiping rail is provided running together with the headstock, which corresponds to the contour of the guide rail, respectively the opening, for the headstock in the wall of the machining room, and the wiping rail consists of several parts or is formed by a special profile sheet with wiper.

18. The Machine tool according to claim 1, characterised in that a wiping rail is provided running together with the headstock which corresponds to the contour of the guide rail, respectively the opening, for the headstock in the wall of the machining room, and that the wiping rail has lips.

19. The Machine tool according to claim 1, characterised in that a wiping rail is provided running together with the headstock which corresponds to the contour of the guide rail, respectively the opening, for the headstock in the wall of the machining room, and another part of the wiping rail is arranged below the headstock.

20. The Machine tool according to claim 1, characterised in that on the end of the headstock which faces towards the machining room brushes are arranged as protection against impurities.

21. The Machine tool according to claim 1, characterised in that a carriage is provided which carries the guide rails for the guide block of the headstock and can be shifted at least transverse to the longitudinal axis of the spindle.

22. The Headstock for a machine tool for receiving one or more tool spindle(s) each carrying a tool, characterised in that the headstock carries at least one guide block which can move on guide rails into the machining room of a machine tool, in particular of a machine tool according to claim 1.

23. The Headstock according to claim 22, characterised in that the headstock has several guide blocks and the guide block closest to the tool is set back versus the tool.

24. Method for cleaning guide rails, in particular guide rails of a headstock in a machine tool with at least one headstock for one or more tool spindles with a spindle head, where the headstock can be shifted in the direction of the spindle axis and at least one guide block for the headstock is provided which can move on a guide rail, and the headstock carries the guide block, characterised in that the headstock is run into the machining room of the machine tool, while a wiping rail arranged on the headstock runs up to the end of the guide rails projecting into the machining room, and, simultaneously, wipes off dirt deposited there, and, after that, the spindle is run back.

25. The Method according to claim 24, characterised in that brushes arranged on the headstock protect, respectively brush off, the guide rails at least when the headstock is run back.
